(19) United States
(12) Patent Application Publication
(10) Pub. No.: US 2022/0253741 A1
(43) Pub. Date: Aug. 11, 2022

(54) QUANTUM PROCESSING OF PROBABILISTIC NUMERIC CONVOLUTIONAL NEURAL NETWORKS

(71) Applicant: QUALCOMM Incorporated, San Diego, CA (US)

(72) Inventors: Roberto BONDESAN, Amsterdam (NL); Max Welling, Bussum (NL)

(21) Appl. No.: 17/649,896

(22) Filed: Feb. 3, 2022

Related U.S. Application Data
(60) Provisional application No. 63/145,928, filed on Feb. 4, 2021.

(51) Int. Cl. G06N 10/20; G06F 17/18

(52) U.S. Cl. CPC G06N 10/20; G06F 17/18

(57) ABSTRACT

Certain aspects of the present disclosure provide techniques for performing probabilistic convolution operation with a quantum and non-quantum processing systems.

### CROSS-REFERENCE TO RELATED APPLICATIONS

This Application claims the benefit of and priority to U.S. Provisional Patent Application No. 63/145,928, filed Feb. 4, 2021, the entire contents of which are incorporated herein by reference.

### INTRODUCTION

Aspects of the present disclosure relate to quantum processing in machine learning.

Quantum computing promises to unlock previously inconceivable computing performance for various types of processing tasks. For example, quantum computing can perform extremely fast and power efficient matrix multiplication operations. Thus, quantum computing is an excellent candidate for computationally intensive tasks, like machine learning.

Unfortunately, applying quantum computing to conventional machine learning presents many challenges, and thus various state of the art machine learning architectures have not been successfully implemented on quantum computing hardware.

Accordingly, what is needed are techniques for implementing machine learning architectures in quantum computing hardware, such as optical quantum computing hardware.

### BRIEF SUMMARY

Certain aspects provide a method, comprising: performing a probabilistic convolution operation with an optical quantum computer, wherein input signals to the probabilistic convolution operation are encoded in light beams.

Other aspects provide a method, comprising simulating a quantum probabilistic convolution operation using a non-quantum processing system.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example covariance ellipse representing a quantum blob.

FIG. 2 depicts an example method for performing quantum probabilistic convolution.

FIG. 3 depicts an example processing flow using quantum optical processing equipment.

FIG. 4A depicts an example of a quantum processing system.

FIG. 4B depicts an example processing system for performing simulation of quantum processing of probabilistic numeric convolutional neural networks on non-quantum computing hardware.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for quantum processing of probabilistic numeric convolutional neural networks, such as by quantum computers. Further aspects relate to simulating quantum processing of probabilistic numeric convolutional neural networks on non-quantum processing systems.

In particular, aspects described herein apply quantum field theory to machine learning by encoding input signals to Gaussian states (a generalization of Gaussian processes that encodes the uncertainty about an input signal), representing linear and nonlinear layers of a machine learning model as unitary quantum gates, and interpreting the fundamental excitations of the quantum model as particles. Thus, aspects described herein provide a quantum field interpretation of classical probabilistic neural network model architectures, which beneficially allows for processing using quantum processing hardware, such as optical quantum processing systems.

Beneficially, the use of Gaussian states instead of conventional Gaussian processes allows for encoding and accounting for uncertainty due to discretization and sampling errors in, for example, light used by an optical quantum computer. Further, the implementation of nonlinear functions using unitary quantum gates that leverage quantum effects significantly reduces required processing resources compared to conventional methods.

Further, aspects described herein enable a quantum implementation and generalization of a probabilistic numeric convolutional neural network.

Aspects described herein may be particularly beneficial for irregularly sampled data, such as time-series data, superpixel image data, and the like.

### Probabilistic Numeric Convolutional Neural Networks

Probabilistic numeric convolutional neural networks (PNCNNs) may be used for classifying an input signal with missing data. Such models generally use a Gaussian process on a continuous space X= [symbol] ^{D} to interpolate the input signal, and define the convolutional neural network based on the Gaussian process representation.

Consider a finite dimensional input space wherein input to a PNCNN is D={(xᵢ, yᵢ)}ᵢ₌₁^{N}, which corresponds to the observation yᵢ of an input signal (field) φ:X→ [symbol] at location xᵢ∈X. An underlying finite input grid X={1, . . . , l}x^{×d} , where d is the dimensionality of the input data (e.g., d=1 for time series data, d=2 for image data, etc.) and ×d indicates the dimensionality grid X, may be denoted by φ, a vector with components φₓ. Further, a prior Gaussian process (GP) with mean equal to zero and kernel k may be used to compute a posterior GP (μ′, k′) to interpolate the input signal as follows:

μ′ₓ=kₓ^{T}A⁻¹y, k′_{x,x′}−kₓ^{T}A⁻¹k_{x′} (1)

where kₓ={k_{x,x}_{ᵢ}}ᵢ₌₁^{N}, A_{i,j}=kₓ_{ₓ}_{,x}_{ⱼ}+δ_{i,j}σₙ², and σₙ² is measurement of noise. A sequence of convolutional layers and nonlinearities may then be applied on the input random vector φ⁽¹⁾˜GP (μ′, k′) according to:

[symbol]

=σ( [symbol] ( [symbol] )) (2)

where [symbol] +1 is the next layer in a convolutional neural network. In the intermediate layers, φ has shape N_{C}×|X|, with N_{C} being the number of channels and components φ_{a,x} and |X| being the number of points in the set X. Further, σ is a pointwise nonlinearity, B adds a bias, and [symbol] is linear according to:

[symbol]

=ΣₖWₖ [symbol] (3)

where [Wₖ]^{ab} is a matrix of parameters, a, b index the channels, and

Dₖ=Σᵢ_{_{1, . . . ,}} ᵢ_{_{d}}_{≥0}αᵢ_{_{d}}∂₁ⁱ^{₁} . . . ∂_{d}ⁱ^{_{d}} (4)

where the unit vector in direction μ∈{1, . . . , d} is denoted by e_{μ}, (∂_{μ}φ)ₓ=φₓ₊ₑ_{_{μ}}−φₓ and αᵢ_{_{1, . . . ,}} ᵢ_{_{d}} is constant. In Equation 3, above, the operator [symbol] is the formal solution to an ordinary differential equation that represents the convolution operation.

After L transformations according to Equation 2, the output feature undergoes a global average pooling, [symbol] =P [symbol] , where:

$${( P φ )}_{a , x} = \{ \begin{matrix}\frac{1}{\vert X \vert} {\sum }_{x ∈ X} {φ}_{a , x} & first element \\ {φ}_{a , x} & else\end{matrix} \qquad ( 5 )$$

This implements an invertible version of the global average pooling layer. Finally, the first element of φ^{(L+1)} is passed through a linear layer that produces an output whose mean is interpreted as logits for classification. Denoting [symbol] = [symbol] ∘ [symbol] , the chain of operations of the PNCNN is thus:

Φ= [symbol] P∘σ∘ [symbol] ∘ . . . ∘ [symbol] ⁽⁰⁾ (6)

where ∘ denotes a convolution operation.

### Brief Introduction to Quantum Mechanics

In the quantum formalism, every classical configuration of a random field φ={φₓ}_{x∈X}∈ [symbol] ^{|X|} (where channels are ignored here for simplicity) is associated with a vector φ. The span of all these vectors is a vector space H, with elements given by superpositions |ψ [symbol] according to:

|Ψ [symbol] =∫D(φ)ψ(φ)|φ′, D(φ=Π_{x∈X}dφₓ (7)

Note that ψ(φ) are the coefficients ∈ [symbol] (complex numbers) that are used to combine vectors |φ [symbol] . The Hilbert space H is equipped with a scalar product [symbol] φ|φ′′=δ(φ−φ′), so that [symbol] φ|Ψ [symbol] =ψ(φ). A linear operator on H is called a quantum field (indicated with a hat). The algebra of quantum fields is generated by the pairs {\hat{φ}ₓ, \hat{π}ₓ}_{x∈X} as follows:

$$\begin{matrix}〈 φ \vert {\hat{φ}}_{x} \vert Ψ 〉 = {φ}_{x} ψ ( φ ) & ( 8 ) \\ φ {\hat{π}}_{x} Ψ = - i \frac{\partial }{\partial {φ}_{x}} ψ ( φ ) & ( 9 )\end{matrix}$$

Note that equations 8 and 9 are self-adjoint and satisfy the canonical commutation relations:

[\hat{φ}ₓ,\hat{π}_{x′}]:=\hat{φ}ₓ\hat{π}_{x′}−\hat{π}_{x′}\hat{φ}ₓ=iδ_{x,x′} (10)

There will often be a need to compute analytic functions of operators O, e.g. f(O)=e^{O}, which may be defined by the Taylor expansion of f. O may be a function of \hat{φ} and \hat{π}, such as defined in the Hamiltonian of Equation 31, below.

Generally, a quantum state is a normalized superposition: [symbol] Ψ [symbol] =1. The expectation values of an operator O can thus be defined by its matrix elements in a state [symbol] Ψ|O|Ψ [symbol] , which reduces to classical expectation values when O is diagonal according to [symbol] Ψ|O|Ψ [symbol] =∫D(φ)D(φ′) [symbol] Ψ|φ [symbol] [symbol] φ|O|φ′ [symbol] [symbol] φ′|Ψ [symbol] = [symbol] _{φ˜|ψ(φ)|}_{²}[O(φ)].

Quantum dynamics needs to preserve the norm of quantum states and acts by unitary operators Û=e^{-itĤ}, where Ĥ is a self-adjoint Hamiltonian. Instead of evolving states, the observables Â to be measured can be equivalently evolved according to: Â(t)=(Û^{t}) [symbol] ÂÛ^{t}, which can be computed using the Baker-Campbell-Hausdorff formula:

$${e}^{+ it \hat{H}} \hat{A} {e}^{- it \hat{H}} = \hat{A} + it [ \hat{H} , \hat{A} ] - \frac{{t}^{2}}{2} [ \hat{H} , [ \hat{H} , \hat{A} ] ] + … \qquad ( 11 )$$

Equivalently, time evolution is described by the Heisenberg equation of motion:

$$\frac{d \hat{A} ( t )}{dt} = i [ \hat{H} , \hat{A} ( t ) ] \qquad ( 12 )$$

Measurements generally reduce a quantum superposition to a classical configuration. This projection |Ψ [symbol] [symbol] |φ [symbol] occurs with probability |ψ( [symbol] )|².

Consider the following proposition: let |Ψ [symbol] be a prior state in H=H₁⊗H₂. If a measurement on H₁ gives outcome y₁ then then posterior state is:

|ζ_{y}_{₁} [symbol] =(P_{y}_{₁}⊗1₂)|Ψ [symbol] /

[symbol]

with P_{y}=|y [symbol] [symbol] y|, the projector on state |y [symbol] .

Notably, Bayes rule follows from this proposition. Thus, a subsequent measurement of an observable on H₂ with outcome y₂ on the state |ζ_{y}_{₁} [symbol] will give outcome probability:

$$p ( {y}_{2} \vert {y}_{1} ) = 〈 {ζ}_{{y}_{1}} \vert {1}_{1} ⊗ {P}_{{y}_{2}} \vert {ζ}_{{y}_{1}} 〉 = \frac{〈 Ψ \vert {P}_{{y}_{1}} ⊗ {P}_{{y}_{2}} \vert Ψ 〉}{〈 Ψ \vert {P}_{{y}_{1}} ⊗ {1}_{2} \vert Ψ 〉} \qquad ( 13 )$$

which coincides with p(y₁, y₂)/p(y₁).

### Introduction to Gaussian States

Consider the 2|X| dimensional vector of operators:

\hat{R}=(\hat{φ}₁, . . . , \hat{φ}_{|X|}, \hat{π}₁, . . . , \hat{π}_{|X|}) (14)

After introducing the symplectic form J, Equation 10 reads as:

$$[ {\hat{R}}_{i} , {\hat{R}}_{j} ] = i {J}_{ij} , J = ( \begin{matrix}0 & {1}_{\vert X \vert} \\ - {1}_{\vert X \vert} & 0\end{matrix} ) \qquad ( 15 )$$

Gaussian states are specified uniquely by their mean and covariance defined as:

m= [symbol] Ψ|\hat{R}|Ψ [symbol] (16)

½Cᵢⱼ= [symbol] Ψ|½(\hat{R}ᵢ\hat{R}ⱼ+\hat{R}ⱼ\hat{R}ᵢ)|Ψ [symbol] −mᵢmⱼ (17)

Here and below, the first and second |X| components related to \hat{φ}, \hat{π} sectors are denoted by 1, 2:

$$m = ( {m}^{1} , {m}^{2} ) , C = ( \begin{matrix}{C}^{11} & {C}^{12} \\ {C}^{21} & {C}^{22}\end{matrix} ) \qquad ( 18 )$$

The covariance matrix C satisfies:

C=C^{T}, C>0, C+iJ≥0 (19)

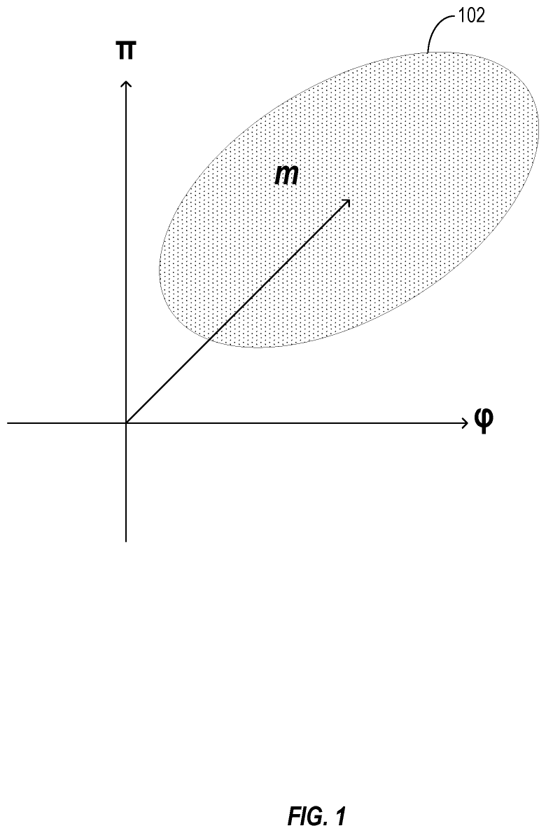

The condition C+iJ>0 encodes the uncertainty principle and distinguishes quantum Gaussian states from classical Gaussian distributions on phase space. FIG. 1 gives a visualization of this fact. In particular, in FIG. 1 depicts a covariance ellipse 102 given by ½ (z−m)^{T}C(z−m)≤1, also known as “quantum blob”, in a 2D phase space with coordinates z=(φ, π). The area of covariance ellipse 102 is proportional to Det(C)>1 per the uncertainty principle.

A Gaussian state may be indicated as |m, C [symbol] ². The wave-function [symbol] φ|m, C [symbol] of a Gaussian state is a Gaussian function of φ, albeit with complex quadratic form.

Thus, it can be shown that the following unitary transformations, whose Hamiltonians are at most quadratic in \hat{R}ᵢ, implement the most general transformations among Gaussian states:

$$\begin{matrix}\hat{D} ( ξ ) = {e}^{i {\hat{R}}^{T} j ξ} , ξ ∈ {ℝ}^{2 \vert X \vert} & ( 20 ) \\ \hat{ω} ( S ) = {e}^{\frac{i}{2} {\hat{R}}^{T} JX \hat{R}} , S = {e}^{X} ∈ S {p}_{2 \vert X \vert} ( ℝ ) & ( 21 )\end{matrix}$$

The Lie group Sp_{2|X|} ( [symbol] ) is the symplectic group of matrices satisfying SJS^{T}=J, which include rotations and scaling. An element X in its Lie algebra, S=e^{X}, satisfies JX+X^{T}J=JX−(JX)^{T}=0, so:

(\hat{R}^{T}JX\hat{R}) [symbol] =\hat{R}^{T}JX\hat{R} (22)

which ensures unitarity of \hat{ω}(S). \hat{D} and \hat{ω} implement symmetry transformations (resp. translations and linear symplectic transforms) on H.

It is possible to show that \hat{R} intertwines their action on H and the fundamental action on [symbol] ^{2|X|}. Consider that the unitaries of Equations 20 and 21 represent symplectic affine transformations of the canonical operators:

\hat{D}(ξ) [symbol] \hat{R}\hat{D}(ξ)=\hat{R}+ξ (23)

\hat{ω}(S) [symbol] \hat{R}\hat{ω}(S)=S\hat{R} (24)

The effect on the mean and covariance of Gaussian states can then be derived. Specifically, under the unitaries of Equations 20 and 21, the Gaussian states transform as:

\hat{D}(ξ)|m,C [symbol] =|m+ξ,C [symbol] (25)

\hat{ω}(S)|m,C [symbol] =|Sm,SCS^{T} [symbol] (26)

Thus, for any |Ψ [symbol] :

[symbol]

[symbol]

(ξ) [symbol] \hat{R}\hat{D}(ξ|Ψ [symbol] = [symbol] Ψ|(\hat{R}+ξ)Ψ [symbol] =m+ξ

[symbol]

Ψ|\hat{ω}(S) [symbol] \hat{R}\hat{ω}(S)|Ψ [symbol] =Sm=m′

[symbol]

Ψ|\hat{ω}(S) [symbol] ½(\hat{R}ᵢ\hat{R}ⱼ+\hat{R}ⱼ\hat{R}ᵢ)\hat{ω}(S)|Ψ [symbol] −m′ᵢm′ⱼ=Σ_{k,l}Sᵢₖ½CₖₗSⱼₗ=½(SCS^{T})ᵢⱼ

The result follows by specifying |Ψ [symbol] .

### Quantum Extensions of Probabilistic CNNs

The following introduces a series of quantum operations that generalize the classical layers of a PNCNN. As below, each of these operations has a natural implementation on a quantum optical computer.

### State Preparation

As an example of how to perform Bayesian inference with Gaussian states, let 0, C be a Gaussian prior state such that C_{x,x′}¹¹=k_{x,x′}. Given data D={(xᵢ,yᵢ)}ᵢ₌₁^{N}. Then the posterior may be represented as:

$${ζ}_{D} = \frac{{P}_{D} \vert 0 , C 〉}{‖ {P}_{D} \vert 0 , C 〉 ‖} , {P}_{D} = {\prod }_{i = 1}^{N} {\vert {y}_{i} 〉}_{{x}_{i} {x}_{i}} 〈 {y}_{i} \vert \qquad ( 27 )$$

where |yₓ [symbol] is an eigenstate of \hat{φ}ₓ. Then:

|ζ_{D} [symbol] =|m′,C′ [symbol] , (m′)1/x=μ_{x′}, (C′)_{x,x′}¹¹=k′_{x,x′} (28)

where μ′, k′ is as in Equation 1.

It follows that |Ψ [symbol] =|0, C [symbol] , H₁ is the space corresponding to locations xᵢ and the formulas for the Gaussian conditionals.

Thus, a quantum GP inference step according to Equations 27 and 28 allows for encoding a classical signal onto a quantum state in such a way that the quantum correlations represent uncertainty about discretization errors.

### Quantum Linear Layers

Next, it is possible to show how to perform the quantum equivalent of a linear layer that performs on the quantum fields \hat{R} the same transformation that a classical linear layer would perform on a classical field R.

A quantum linear layer may be defined as the unitary:

Ûₗᵢₙ(ξ,S)=\hat{D}(ξ)\hat{ω}(S) (29)

where \hat{D}(ξ) and \hat{ω}(S) generalize the bias and multiplication by the weight matrix respectively.

### Quantum Nonlinearity

Similar to classical nonlinearities, a quantum nonlinearity acts pointwise on quantum fields. This restricts the associated Hamiltonian to be Σ_{x,a}Ĥ_{x,a}, where Ĥ_{x,a} acts non-trivially only on the quantum fields at x, a. As a design principle, the following class of time evolutions, which map \hat{φ}_{x,a} to a function σ(\hat{φ}_{x,a}), may be considered.

Consider that under the time evolution generated by:

Û_{σ}=exp(−iΣ_{x,a}Ĥ_{x,a}) (30)

Ĥ_{x,a}=½(\hat{π}_{x,a}f(\hat{φ}_{x,a})+f(\hat{φ}_{x,a})\hat{π}_{x,a}) (31)

the fields evolve according to the equations of motion:

\hat{φ}_{x,a}(t)=f(\hat{φ}_{x,a}(t)) (32)

\hat{π}_{x,a}(t)=−½(\hat{π}_{x,a})(t)f′(\hat{φ}_{x,a}(t))+h.c.) (33)

where “h.c.” means the Hermitian conjugate of the expression preceding it.

The following relates σ to f of the previous proposition. The ordinary differential equations for Equations 32 and 33 have solutions:

$$\begin{matrix}{\hat{φ}}_{x , a} ( t ) = {F}^{- 1} ( F ( {\hat{φ}}_{x , a} ( 0 ) ) + t ) & ( 34 ) \\ {\hat{π}}_{x , a} ( t ) = \frac{1}{2} ( {\hat{π}}_{x , a} ( 0 ) \frac{f ( {\hat{φ}}_{x , a} ( 0 ) )}{f ( {\hat{φ}}_{x , a} ( t ) )} + h . c . ) & ( 35 )\end{matrix}$$

where F′(x)=1/f (x). This can be directly confirmed by differentiating with respect to t to show that the time evolved fields satisfy the equation of motions. Rewriting the first equation as F(\hat{φ}_{x,a}(t))=F(\hat{φ}_{x,a}(0))+t and differentiating the left hand side gives:

$${\partial }_{t} F ( {\hat{φ}}_{x , a} ( t ) ) = {F}^{′} ( {\hat{φ}}_{x , a} ( t ) ) {\hat{φ}}_{x , a} ( t ) = \frac{{\hat{φ}}_{x , a} ( t )}{f ( {\hat{φ}}_{x , a} ( t ) )} \qquad ( 36 )$$

which equals ∂ₜ(F(\hat{φ}_{x,a}(0))+t)=1, showing that \hat{φ}_{x,a}(t) satisfies Equation 32. For the second equation, the first term in the parenthesis is differentiated as:

$$\begin{matrix}{\hat{π}}_{x , a} ( 0 ) f ( {\hat{φ}}_{x , a} ( 0 ) ) {\partial }_{t} {( f ( {\hat{φ}}_{x , a} ( t ) ) )}^{- 1} & ( 37 ) \\ = - {\hat{π}}_{x , a} ( 0 ) \frac{f ( {\hat{φ}}_{x , a} ( 0 ) )}{f ( {\hat{φ}}_{x , a} ( t ) )} \frac{{f}^{′} ( {\hat{φ}}_{x , a} ( t ) )}{f ( {\hat{φ}}_{x , a} ( t ) )} {\hat{φ}}_{x , a} ( t ) & ( 38 ) \\ = - {\hat{π}}_{x , a} ( t ) {f}^{′} ( {\hat{φ}}_{x , a} ( t ) ) & ( 39 )\end{matrix}$$

which shows that \hat{π}_{x,a}(t) satisfies Equation 33.

This derivation gives a general, albeit implicit, solution to the problem of constructing a quantum nonlinearity. However, an explicit solution for the case of softplus, a smooth version of ReLU, may be constructed. Specifically, the softplus nonlinearity with temperature parameter β is:

$${σ}_{β} ( x ) = \frac{1}{β} log ( 1 + {e}^{β x} ) \qquad ( 40 )$$

which corresponds to time evolution from time 0 to time 1 under

$${\hat{H}}_{x , a} = \frac{1}{2 β} ( {\hat{π}}_{a , x} {e}^{- β {\hat{φ}}_{a , x}} + {e}^{- β {\hat{φ}}_{a , x}} {\hat{π}}_{a , x} ) \qquad ( 41 )$$

### Quantum Neural Network Architecture

A quantum neural network architecture may be defined by applying the preceding derivations, such that:

Û_{NN}=Ûₗᵢₙ(ξ^{(L)},S^{(L)})Û_{P} [symbol] Û_{σ}Ûₗᵢₙ( [symbol] ) (42)

where Û_{σ} and Ûₗᵢₙ are as designed above, while:

Û_{P}=\hat{ω}(S=P⊕(P⁻¹)^{T}) (43)

is a global average pooling operator, where P is as in Equation 5. To make a prediction, the spatial locations that have not been aggregated over by averaging are discarded, a final linear classifier is applied, and the means \hat{φ}_{c} for the c=1, . . . , C classes are measured according to:

l_{c}= [symbol] ζ_{D}| [symbol] \hat{φ}_{c}Û_{NN}|ζ_{D} [symbol] (44)

These l_{c} are interpreted as the logits for the classification task at hand. For simplicity, the state |ζ_{D} [symbol] was introduced above without referring to the channel dimension. To make sense of the action of Û_{NN} on the channel dimension, extra registers may be added for the channel dimension, which are initialized to the vacuum state, which is a Gaussian state with zero mean and unit covariance. While only a global average pooling at the end is considered in this example, it is possible to pool features in intermediate layers as well by simply discarding registers associated with the modes to be discarded.

Computing the logits of Equation 44 is in general intractable classically and thus requires a quantum computer. The definition of a quantum neural network herein has several advantages. First, Gaussian states are used for data interpolation. Second, a unitary gate is used for implementing the nonlinearity. In particular, the unitary gate implementation of the nonlinearity is far more efficient than other methods, such as using a non-unitary quantum channel to implement a nonlinearity of the type \hat{φ}_{x,a} [symbol] σ(\hat{ω}_{x,a}). Further, employing Hamiltonians, such as:

Ĥ_{cubic}=\hat{φ}_{a,x}³, Ĥ_{Kerr}=(\hat{ω}_{a,x}²+\hat{π}_{a,x}²)² (45)

as nonlinearities, which correspond to low degree polynomial nonlinearities, is known to be inefficient for classical neural network approximation.

### Symmetries in Neural Network Models

Generally, symmetries in classical neural networks are realized as linear maps g∈G that act on the activations φ as ρ(g)φ, where ρ is a representation matrix. On top of translations, prominent examples of G in machine learning include rotations and permutations. Having replaced the linear action on activations with \hat{ω}, unitary representations of G on quantum states may be defined by \hat{ω}(S_{g}:=ρ(g)⊕ρ*(g)), where ρ*(g)=ρ(g⁻¹)^{T} is the dual representation, ensuring symplecticity of S_{g}. Thus:

$${\hat{ω} ( {S}_{g} )}^{†} ( \begin{matrix}\hat{φ} \\ \hat{π}\end{matrix} ) \hat{ω} ( {S}_{g} ) = ( \begin{matrix}ρ ( g ) \hat{φ} \\ {ρ}^{*} ( g ) \hat{π}\end{matrix} ) \qquad ( 46 )$$

For example, in case of translations along the μ∈{1, . . . , d} axis, (τ_{μ}φ)_{a,x}=φ_{a,x+e}_{_{μ}}, and S_{τ}_{_{μ}}=τ_{μ}⊕τ_{μ}, which translates both \hat{φ}, \hat{π} variables.

Equivariance of a quantum linear layer \hat{ω}(S) now amounts to the commutation relations:

\hat{ω}(S)\hat{ω}(S_{g})=\hat{ω}(S_{g})\hat{ω}(S)⇒SS_{g}=S_{g}S (47)

where the second formula follows from the group homomorphism property: \hat{ω}(S)\hat{ω}(S′)=\hat{ω}(SS′). The characterization of symmetries presented herein completely solves the problem of designing equivariant quantum linear layers by reducing the problem to designing equivariant classical linear layers with symplectic weight matrices S which intertwine the action of ρ(g)⊕ρ*(g). Similar to the classical case, since the nonlinearities act pointwise, they will be invariant under operations that permute the coordinates (\hat{φ}_{x,a}, \hat{π}_{x,a}) [symbol] (\hat{φ}_{x′,a′}, \hat{π}_{x′,a′}), such as spatial symmetries, ensuring equivariance of the whole architecture.

As an illustration, with the parametrization S=e^{X}∈Sp_{2M}( [symbol] ), the condition SS_{τ}_{_{μ}}=S_{τ}_{_{μ}}S restricts X to the form:

$$X = ( \begin{matrix}A & B \\ C & D\end{matrix} ) \qquad ( 48 )$$

where each M×M block of Xis a convolution.

### Particle Interpretation of Quantum Formalism for Neural Networks

The quantum formalism described herein is amenable to a particle interpretation for neural networks. To that end, the following operators are introduced:

$$\hat{a} = \frac{1}{\sqrt{2}} ( \hat{φ} + i \hat{π} ) , {\hat{a}}^{†} = \frac{1}{\sqrt{2}} ( \hat{φ} - i \hat{π} ) \qquad ( 49 )$$

A particle basis (e.g., a Fock space) may then be used for H, where a zero mean and unit covariance Gaussian state are identified with no particles [symbol] (vacuum)|Ω [symbol] =|0,1 [symbol] such that [symbol] Ω [symbol] =0, and an orthogonal basis is created by acting with different monomials ( [symbol] )ⁿ^{ᵢ} . . . ( [symbol] )ⁿ^{ₘ} on |Ω [symbol] nᵢ being the number of particles at location a,x. In the quantum optical setting, the particles are called photons. In the neural network context, these fundamental excitations may be referred to as “Hintons.”

### Deep Linear Quantum Networks

Despite producing entangled states, the quantum linear layers acting on Gaussian states can be simulated efficiently on a classical computer. At this level, the only difference between a quantum evolution and a probabilistic classical evolution of a Gaussian Liouville measure in phase space is the covariance condition C+iJ≥0 coming from the non-commutativity of position and momenta in quantum mechanics. Notably, this condition is preserved by classical evolution thanks to the symplectic nature of classical mechanics.

### Embedding Classical Probabilistic Neural Networks in a Quantum Architecture

Now it is possible to show how a classical probabilistic neural network can be embedded in the quantum model discussed above with respect to Equations 42-44.

First, it can be shown that the following representation of the push forward of a Gaussian process under a generic classical (invertible) map is a unitary operation.

Let |m, C [symbol] be a Gaussian state and Û a unitary such that:

[symbol]

\hat{ω}Û=F(\hat{φ}) (50)

Then:

⊕φÛm,C|²=(F#GP(m¹,C¹¹))(φ) (51)

where f#p denotes the push forward of p under f.

It is already known that Û_{σ} has this property, so the quantum linear layers only need to be constrained so that they do not mix \hat{φ} with \hat{π}.

Consider the unitary of Equation 42 with:

$${S}^{( ℓ )} = ( \begin{matrix}{A}^{( ℓ )} & 0 \\ 0 & {( {( {A}^{( ℓ )} )}^{- 1} )}^{T}\end{matrix} ) , {ξ}^{( ℓ )} = ( {b}^{( ℓ )} , 0 ) \qquad ( 52 )$$

Then there is the quantum-classical duality:

| [symbol] φ|Û_{NN}|ζ_{D} [symbol] ²=(Φ#GP(μ′,k′))(φ) (53)

where the right hand side of Equation 53 is the push forward of the Gaussian process posterior of Equation 1 under the PNCNN map Φ of Equation 6. This shows that the logits of Equation 44 computed by the quantum neural network coincide with those computed by a PNCNN with weights and biases [symbol] ,

[symbol]

### The Semiclassical Limit

Let R=(φ,π) denote the classical fields corresponding to the quantum operators introduced above (where the quantum operators include a hat accent).

The preceding discussion has established two tractable limits of the quantum model. For example, as above, the quantum model reduces to the push forward of a Gaussian Liouville distribution with constrained covariance C+iJ≥0 under the linear layer action. Further, restricting the linear layers to block diagonal matrices leads to the classical model, which also corresponds to the push of an initial Gaussian Liouville distribution under a neural network, but this time only involving the φ field.

A nonlinearity may be modified in such a way that the modified model corresponds to the push forward of an initial Gaussian measure under a neural network, involving both the φ and the π fields. To do that, Û_{σ} may be replaced with a classical Hamiltonian evolution under which the phase space measure evolves into a new classical phase space measure.

Under the classical time evolution generated by the Hamiltonian:

H=Σ_{x,a}π_{x,a}f(φ_{x,a}) (54)

and the fields transform as:

$$\begin{matrix}{φ}_{x , a} ( t ) = {F}^{- 1} ( F ( {φ}_{x , a} ( 0 ) ) + t ) & ( 55 ) \\ {π}_{x , a} ( t ) = {π}_{x , a} ( 0 ) \frac{f ( {φ}_{x , a} ( 0 ) )}{f ( {φ}_{x , a} ( t ) )} & ( 56 )\end{matrix}$$

where F′(x)=1/f (x).

Notably, the classical and quantum equations of motions and solutions look identical. This is a consequence of the correspondence between quantum and classical mechanics under the identification [Â, Ĥ]↔iℏ{A, H}.

A neural network may then be defined that pushes forward the input Gaussian Liouville distribution on phase space to an output distribution pₒᵤₜ by chaining linear and nonlinear classical layers. Its mean is interpreted as the logits for classification:

logit_{c}= [symbol] _{φ}_{_{c}}_{˜p}_{ₒᵤₜ}(φ_{c}) (57)

The resulting model can then be interpreted as a semi-classical limit of the quantum model since it uses elements of quantum mechanics (uncertainty relation for the covariance) as well as classical mechanics (for the nonlinearity).

The classical counterpart of the quantum softplus defined above may be obtained by replacing operators with classical variables as:

$${U}_{σ} : ( \begin{matrix}φ \\ π\end{matrix} ) ↦ ( \begin{matrix}\frac{1}{β} log ( 1 + {e}^{βφ} ) \\ π ( 1 + {e}^{- βφ} )\end{matrix} ) \qquad ( 58 )$$

Notably, the nonlinearity of Equation 62, below, can lead to very large values of π when an entry of φ is large and negative due to the exponential. To cure this problem, a given nonlinearity σ can be associated with the following symplectic map.

For any smooth function σ, the following nonlinear map is symplectic:

$${U}_{σ} : ( \begin{matrix}φ \\ π\end{matrix} ) ↦ ( \begin{matrix}σ ( φ ) \\ {π ( {σ}^{′} ( φ ) )}^{- 1}\end{matrix} ) \qquad ( 59 )$$

To prove this, it needs to be the case that the Jacobian is symplectic over the whole space for any smooth σ. The Jacobian is diagonal in the channel and X space and is:

$$( \begin{matrix}{σ}^{′} ( {φ}_{a , x} ) & 0 \\ & {( {σ}^{′} ( {φ}_{a , x} ) )}^{- 1}\end{matrix} ) \qquad ( 60 )$$

Since any 2×2 matrix with unit determinant is symplectic, this proves the the nonlinear map above is symplectic. Therefore to cure the divergence problem of the symplectic softplus, a leaky version may be defined as:

$$σ ( φ ) = \frac{log ( 1 + {e}^{( β - α ) φ} )}{β - α} + αφ \qquad ( 61 )$$

so that:

$${U}_{σ} : ( \begin{matrix}φ \\ π\end{matrix} ) ↦ ( \begin{matrix}\frac{log ( 1 + {e}^{( β - α ) φ} )}{β - α} + αφ \\ π ( {e}^{βφ} + {e}^{αφ} ) {( ( 1 + α ) {e}^{βφ} + α {e}^{- αφ} )}^{- 1}\end{matrix} ) \qquad ( 62 )$$

Testing the semiclassical neural network with the leaky softplus nonlinearity on a simple proof of principle task showed similar performance to that of a classical neural network, which validates the use of the leaky softplus as nonlinearity for this task.

### Quantum Optical Implementation

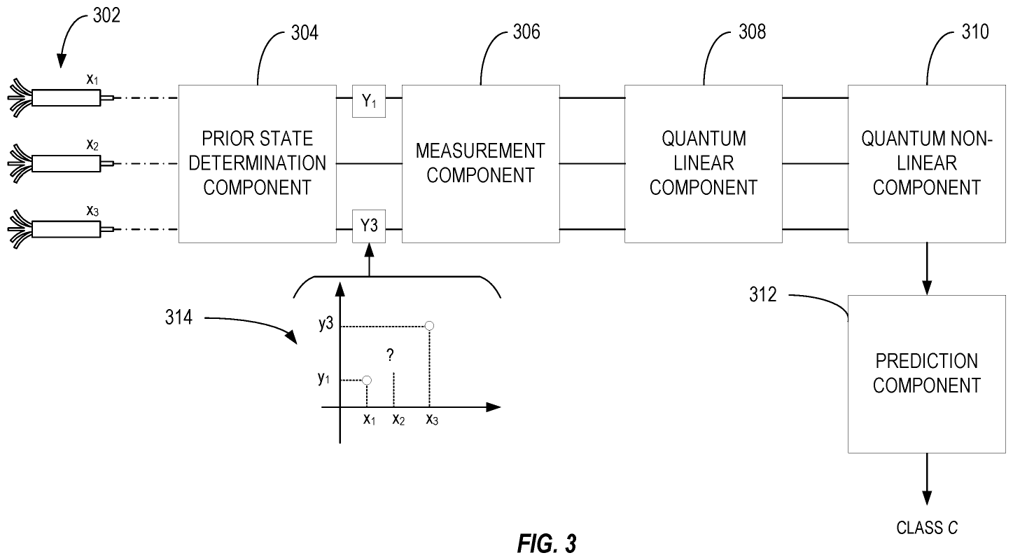

By identifying [symbol] as a photon creation operator, it is possible to map a unitary operator onto a set of quantum optical gates. Optical devices are attractive since one can implement matrix multiplication in a very efficient way. A graphical depiction of the proposed implementation is depicted in FIG. 3. The following reviews the implementation of linear layers in quantum optical implementations, and then explains how to implement the quantum softplus nonlinearity and the data embedding in a Gaussian state.

### Linear Layer of Quantum Optical Implementation

A unitary \hat{φ}(S) may be implemented in a quantum optical computer according to the following steps. First, the unitary is decomped in terms of elementary linear optical gates. To this end, the group homomorphism property \hat{ω}(S)\hat{ω}(S′)=\hat{ω})(SS′) may be used together with the Bloch-Messiah decomposition S=KΣL with K, L symplectic and orthogonal and Σ=diag(e^{r}^{₁}, . . . , e^{r}^{_{M}}, e^{-r}^{₁}, . . . , e^{-r}^{_{M}}) . Σ can be implemented directly using optical parametric amplifiers. The orthogonal matrices K, L can be further decomposed using Givens rotations as product of rotations of two components and implemented in terms of beamsplitters and phase shifters.

### State Preparation of Quantum Optical Implementation

Encoding the input signal D={(xᵢ, yᵢ)}ᵢ₌₁^{N} starts from the vacuum state |Ω|, as defined above, which can be created using lasers. Then, the operator \hat{ω})(S=A⊕(A⁻¹)^{T}) act as discussed above. The state \hat{ω})(S=A⊕⁻¹)^{T})|Ω [symbol] is the prior Gaussian state with prior kernel k=AA^{T}—note that there is no loss of generality since any positive matrix k can always be factorized as k=AA^{T}. The input is conditioned on data by measuring the operators \hat{φ} at xᵢ. The state is then prepared as |y [symbol] ₓ=|y₁ [symbol] ₓ_{₁}⊗ . . . ⊗|y_{N} [symbol] ₓ_{_{N}} as the limit of squeezed states, which can be implemented efficiently.

### Nonlinearity of Quantum Optical Implementation

Quantum computers can perform arbitrary computations if given a set of universal gates. For quantum optical computers, one can take the quadratic Hamiltonians and the cubic gate, whose Hamiltonian is \hat{φ}³. The following is an example of how to implement a nonlinearity with a Hamiltonian (as in Equation 54) where the Taylor series of the function f is truncated to order k:

Ĥ=Σ_{x,a} [symbol] Ĥₗ, [symbol] =½(\hat{π}_{x,a} [symbol] + [symbol] \hat{π}_{x,a}) (63)

Then, the standard procedure for quantum simulation can be used to implement e^{iĤ}^{^{(K)}}.

A first step is to trade e^{im∈Ĥ} for the m times application of [symbol] , so that the problem reduces to how to implement [symbol] . This is explained by the following.

Initially, define the unitaries:

[symbol]

=exp(i∈ [symbol] ) (64)

Then, define [symbol] =−1/(4( [symbol] +2)), such that:

[symbol]

= [symbol] +O(∈^{3/4}) (65)

[symbol]

= [symbol] (66)

[symbol]

= [symbol] (67)

Since Û_{1,∈} has a quadratic Hamiltonian, the quantum gates can be built recursively using only \hat{π}² and \hat{φ}³.

Thus, an explicit decomposition may be derived using only the universal Hamiltonians \hat{π}_{x,a}, \hat{π}_{x,a}², and \hat{φ}_{x,a}³, which allows implementation on a quantum optical device.

### Example Method for Performing Quantum Probabilistic Convolution

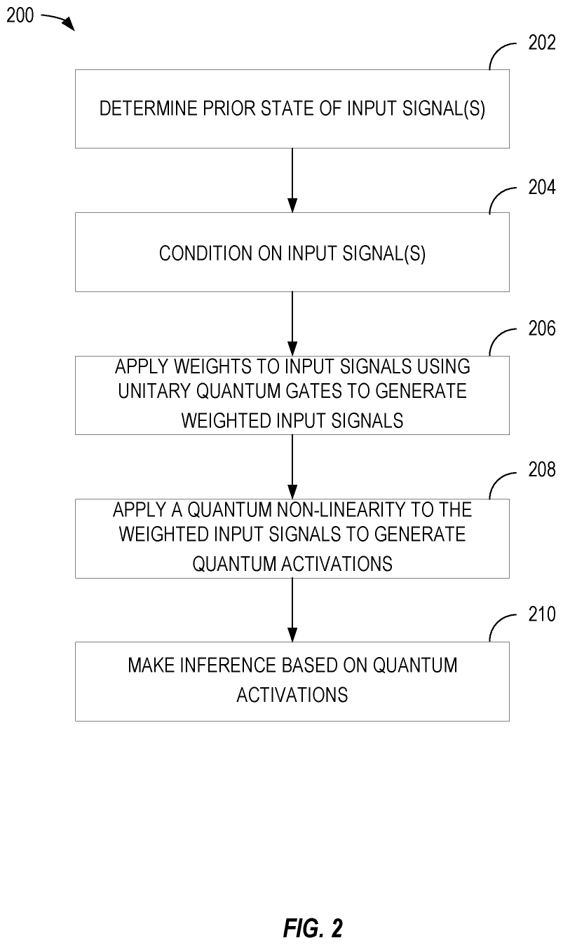

FIG. 2 depicts an example method 200 for performing quantum probabilistic convolution, such as with a quantum numeric probabilistic convolutional neural network as described herein.

Method 200 begins at step 202 with determining prior states of input signals. In some cases, the input signals may be laser light beams encoding input data.

Method 200 then proceeds to step 204 with conditioning on the input signals. For example, the input signals may be conditioned on by measuring the input signals at various times.

Method 200 then proceeds to step 206 with applying weights to the input signals to generate weighted input signals. For example, unitary quantum gates may be used to apply the weights to the input signals.

In some cases, such as where the input signals are encoded in light, optical components, such as beam splitters, phase shifters, optical parametric amplifiers, movable mirrors, movable lenses, and the like, may be used to apply the weights to the light beams (e.g., physical input signals).

Method 200 then proceeds to step 208 with applying a quantum nonlinearity to the weighted input signals to generate quantum activations.

In some cases the quantum nonlinearity comprises a quantum softplus nonlinearity to generate quantum activations. In some cases, the quantum nonlinearity comprises a Hamiltonian according to Equation 54.

Method 200 then proceeds to step 210 with making an inference based on the quantum activations.

FIG. 3 depicts an example flow through quantum optical processing equipment. FIG. 3 may thus be an example of implementing method 200 on a quantum processing system.

For example, laser emitters 302 may emit input signals in the form of laser light beams.

Prior state determination component 304 may use, for example, an interferometer to determine the prior state of each of the light-based input signals.

Measurement component 306 may condition on the input signals by measuring the input signals at various times, such as shown at 314. Note that the measured samples are not complete (e.g., there is a y₁ and y₃ measurement, but no measurement y₂)—thus a probabilistic-type convolution operation is necessary. In some examples, measurement component may be implemented as a quantum Gaussian process to create a posterior state.

Quantum linear component 308 may apply weights to the input signals, such as described above. Quantum linear component 308 thus acts like the quantum equivalent to a classical convolution layer.

In some examples, applying weights to light-based input signals may include the use of various optical components, such as beam splitters, movable mirrors, phase shifters, and others.

Quantum nonlinear component 310 may then apply a quantum nonlinearity to the weighted input signals, such as described above, to generate quantum activation data.

Prediction component 312 may then generate a prediction, such as a class prediction, based on the quantum activation data. For example, an observable may be measured with a detector to determine a resulting class, C, for classifying the input signal.

Note that FIG. 3 represents a simplified flow of the process of FIG. 2. In other examples, additional quantum linear operators (e.g., 308) and quantum nonlinear operators (e.g., 310) may be used to generate quantum equivalent to a probabilistic numeric convolutional neural network.

### Example Processing System for Performing Quantum Processing Of Probabilistic Numeric Convolutional Neural Networks

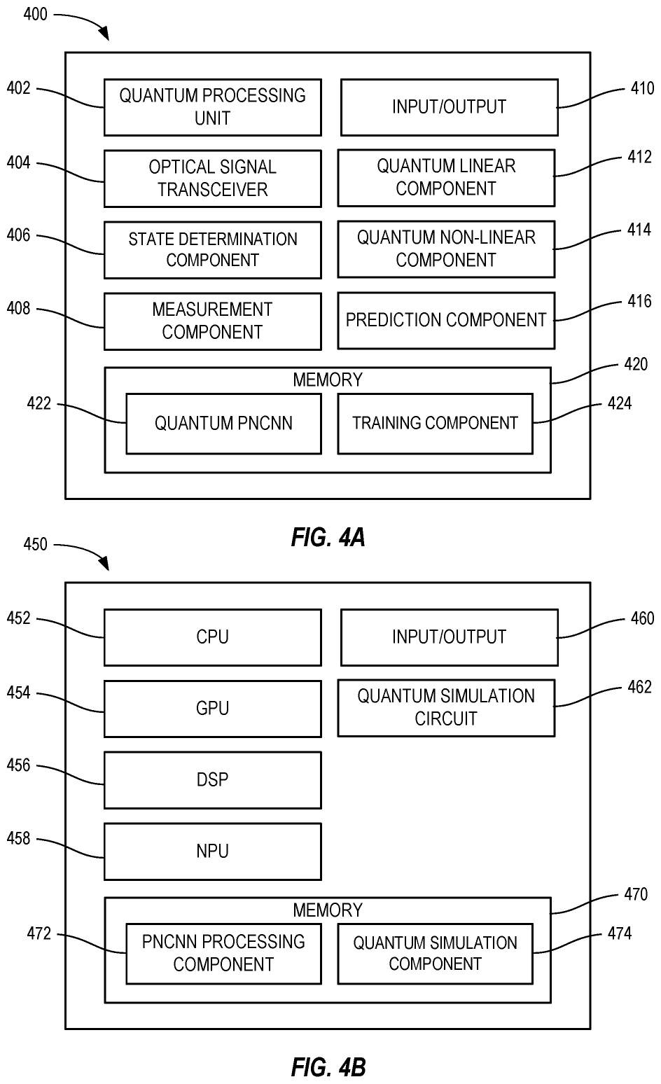

FIG. 4A depicts an example of a quantum processing system 400.

Quantum processing system 400 includes a quantum processing unit 402, which may be configured to perform processing of quantum computing data.

Quantum processing system 400 further includes an optical signal transceiver configured for sending and receiving optical signals, such as laser light beams.

Quantum processing system 400 further includes state determination component 406, such as described above with respect to 304 in FIG. 3. In some examples, state determination component may include an optical interferometer.

Quantum processing system 400 further includes measuring component 408, such as described above with respect to 306 in FIG. 3. For example, measuring component 408 may be configured to determine characteristics, including quantum characteristics, of various signals, such as input signals. As above, the input signals may be laser light beam-based signals in some examples.

Quantum processing system 400 further includes input and output components 410, such as screens, touch-sensitive surfaces (including touch-sensitive displays), physical buttons, speakers, microphones, and the like.

Quantum processing system 400 further includes quantum linear component 412, such as described above with respect to 308 in FIG. 3. In some examples, quantum linear component may include beam splitters, phase shifters, optical parametric amplifiers, movable mirrors, movable lenses, and other optical components.

Quantum processing system 400 further includes quantum nonlinear component 414, such as described above with respect to 310 in FIG. 3.

Quantum processing system 400 further includes prediction component 416, such as described above with respect to 312 in FIG. 3.

The depicted components, and others not depicted, may be configured to perform various aspects of the methods described herein, including method 200 of FIG. 2.

Notably, in other embodiments, aspects of processing system 400 may be omitted, and other aspects may be added.

FIG. 4B depicts an example processing system 400 for performing simulation of quantum processing of probabilistic numeric convolutional neural networks on non-quantum computing hardware.

Processing system 450 includes a central processing unit (CPU) 452, which in some examples may be a multi-core CPU. Instructions executed at the CPU 452 may be loaded, for example, from a program memory associated with the CPU 452 or may be loaded from a memory partition 470.

Processing system 450 also includes additional processing components tailored to specific functions, such as a graphics processing unit (GPU) 454, a digital signal processor (DSP) 456, and a neural processing unit (NPU) 458.

An NPU, such as 458, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 458, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 458 is a part of one or more of CPU 452, GPU 454, and/or DSP 456.

Processing system 450 may also include one or more input and/or output devices 460, such as screens, touch-sensitive surfaces (including touch-sensitive displays), physical buttons, speakers, microphones, and the like.

Processing system 450 also includes memory 470, which is representative of one or more static and/or dynamic memories, such as a dynamic random access memory, a flash-based static memory, and the like. In this example, memory 470 includes computer-executable components, which may be executed by one or more of the aforementioned processors of processing system 450.

In particular, in this example, memory 470 includes probabilistic numeric convolutional neural network processing component 472 and quantum simulation component 474. Quantum simulation component 474 may generally be configured to simulate quantum processing of a probabilistic numeric convolutional neural network on non-quantum hardware. The depicted components, and others not depicted, may be configured to perform various aspects of the methods described herein.

Processing system 450 further comprises quantum simulation circuit 462, which may generally be configured to simulate quantum processing of a probabilistic numeric convolutional neural network on non-quantum hardware.

Notably, in other embodiments, aspects of processing system 450 may be omitted, and other aspects may be added.

### Example Clauses

Implementation examples are described in the following numbered clauses:

Clause 1: A method, comprising: performing a probabilistic convolution operation with an optical quantum computer, wherein input signals to the probabilistic convolution operation are encoded in light beams.

Clause 2: The method of Clause 1, wherein performing the probabilistic convolution operation comprises determining one or more prior states of the input signals using an interferometer.

Clause 3; The method of any one of Clauses 1-2, wherein performing the probabilistic convolution operation further comprises conditioning the input signals by measuring the light beams at a plurality of times.

Clause 4: The method of any one of Clauses 1-3, wherein performing the probabilistic convolution operation further comprises projecting weights onto the input signals using a plurality of unitary quantum gates to generate weighted input signals.

Clause 5: The method of Clause 4, wherein projecting weights onto the input signals further comprises applying one or more of a beam splitter and a phase shifter to the light beams encoding the input signals.

Clause 6: The method of any one of Clause 1-4, wherein performing the probabilistic convolution operation further comprises applying a quantum nonlinearity to the weighted input signals to generate quantum activations.

Clause 7: The method of Clause 6, wherein the quantum nonlinearity comprises a quantum softplus nonlinearity.

Clause 8: The method of Clause 7, wherein the quantum nonlinearity comprises a Hamiltonian according to Equation 54.

Clause 9: The method of any one of Clauses 6-8, further comprising performing a prediction based on the quantum activations.

Clause 10: A method, comprising simulating a quantum probabilistic convolution operation using a non-quantum processing system.

Clause 11: The method of Clause 10, wherein simulating the quantum probabilistic convolution operation comprises determining one or more prior states of one or more input signals.

Clause 12: The method of any one of Clauses 10-11, wherein simulating the quantum probabilistic convolution operation further comprises conditioning the input signals using a Gaussian process.

Clause 13: The method of any one of Clauses 10-12, wherein simulating the quantum probabilistic convolution operation further comprises projecting weights onto the input signals using a plurality of unitary quantum gates to generate weighted input signals.

Clause 14: The method of any one of Clauses 10-13, wherein simulating the quantum probabilistic convolution operation further comprises applying a quantum nonlinearity to the weighted input signals to generate quantum activations.

Clause 15: The method of Clause 14, wherein the quantum nonlinearity comprises a quantum softplus nonlinearity.

Clause 16: The method of Clause 14, wherein the quantum nonlinearity comprises a Hamiltonian according to Equation 54.

Clause 17: The method of any of Clauses 10-16, further comprising performing a prediction based on the quantum activations.

Clause 18: A processing system, comprising: a memory comprising computer-executable instructions; and one or more processors configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
performing a probabilistic convolution operation with an optical quantum computer,
wherein input signals to the probabilistic convolution operation are encoded in light beams.

2. The method of claim 1, wherein performing the probabilistic convolution operation comprises determining one or more prior states of the input signals using an interferometer.

3. The method of claim 2, wherein performing the probabilistic convolution operation further comprises conditioning the input signals by measuring the light beams at a plurality of times.

4. The method of claim 3, wherein performing the probabilistic convolution operation further comprises projecting weights onto the input signals using a plurality of unitary quantum gates to generate weighted input signals.

5. The method of claim 4, wherein projecting weights onto the input signals further comprises applying one or more of a beam splitter and a phase shifter to the light beams encoding the input signals.

6. The method of claim 4, wherein performing the probabilistic convolution operation further comprises applying a quantum nonlinearity to the weighted input signals to generate quantum activations.

7. The method of claim 6, wherein the quantum nonlinearity comprises a quantum softplus nonlinearity.

8. The method of claim 7, wherein the quantum nonlinearity comprises a Hamiltonian according to Equation 54.

9. The method of claim 6, further comprising performing a prediction based on the quantum activations.

10. A method, comprising simulating a quantum probabilistic convolution operation using a non-quantum processing system.

11. The method of claim 10, wherein simulating the quantum probabilistic convolution operation comprises determining one or more prior states of one or more input signals.

12. The method of claim 11, wherein simulating the quantum probabilistic convolution operation further comprises conditioning the input signals using a Gaussian process.

13. The method of claim 12, wherein simulating the quantum probabilistic convolution operation further comprises projecting weights onto the input signals using a plurality of unitary quantum gates to generate weighted input signals.

14. The method of claim 13, wherein simulating the quantum probabilistic convolution operation further comprises applying a quantum nonlinearity to the weighted input signals to generate quantum activations.

15. The method of claim 14, wherein the quantum nonlinearity comprises a quantum softplus nonlinearity.

16. The method of claim 15, further comprising performing a prediction based on the quantum activations.

17. A processing system, comprising:
a memory comprising computer-executable instructions; and
one or more processors configured to execute the computer-executable instructions and cause the processing system to:
perform a probabilistic convolution operation,
wherein input signals to the probabilistic convolution operation are encoded in light beams.

18. The processing system of claim 17, wherein in order to perform the probabilistic convolution operation, the one or more processors are further configured to determine one or more prior states of the input signals using an interferometer.

19. The processing system of claim 18, wherein in order to perform the probabilistic convolution operation, the one or more processors are further configured to condition the input signals by measuring the light beams at a plurality of times.

20. The processing system of claim 19, wherein in order to perform the probabilistic convolution operation, the one or more processors are further configured to project weights onto the input signals using a plurality of unitary quantum gates to generate weighted input signals.

21. The processing system of claim 20, wherein in order to project the weights onto the input signals, the one or more processors are further configured to apply one or more of a beam splitter and a phase shifter to the light beams encoding the input signals.

22. The processing system of claim 20, wherein in order to perform the probabilistic convolution operation, the one or more processors are further configured to apply a quantum nonlinearity to the weighted input signals to generate quantum activations.

23. The processing system of claim 22, wherein the quantum nonlinearity comprises a quantum softplus nonlinearity.

24. The processing system of claim 23, further comprising performing a prediction based on the quantum activations.

25. A method, comprising simulating a quantum probabilistic convolution operation using a non-quantum processing system.

26. The method of claim 25, wherein simulating the quantum probabilistic convolution operation comprises determining one or more prior states of one or more input signals.

27. The method of claim 26, wherein simulating the quantum probabilistic convolution operation further comprises conditioning the input signals using a Gaussian process.

28. The method of claim 27, wherein simulating the quantum probabilistic convolution operation further comprises projecting weights onto the input signals using a plurality of unitary quantum gates to generate weighted input signals.

29. The method of claim 28, wherein simulating the quantum probabilistic convolution operation further comprises applying a quantum nonlinearity to the weighted input signals to generate quantum activations.

30. The method of claim 15, further comprising performing a prediction based on the quantum activations.
